(19) United States
(12) Patent Application Publication
(10) Pub. No.: US 2011/0027576 A1
(43) Pub. Date: Feb. 3, 2011

(54) SEALING OF PINHOLES IN ELECTROLESS METAL COATINGS

(75) Inventors: Lawrence Bernard Kool, Clifton Park, NY (US); Eugenio Giorni, Firenze (IT); Dennis Michael Gray, Delanson, NY (US); Francesco Sorbo, Massa (IT); Steven Alfred Tysoe, Ballston Spa, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, Schenectady, NY (US)

(21) Appl. No.: 12/510,677

(22) Filed: Jul. 28, 2009

(51) Int. Cl. B32B 3/26; B05D 3/12

(52) U.S. Cl. 428/320.2; 427/355

(57) ABSTRACT

The present invention provides a method for sealing pinholes in an electroless metal coating, said method comprising: (a) coating a substrate with an electroless metal coating layer to provide a coated article comprising an electroless metal coating in contact with the surface of the substrate, said electroless metal coating being characterized by the presence of pinhole imperfections which allow fluid communication between the substrate and the environment; (b) applying a layer of a curable epoxy sealant over the electroless metal coating layer and filling the pinhole imperfections; (c) curing the curable epoxy sealant to provide a cured epoxy overcoating layer; and (d) removing a substantial portion of the cured epoxy overcoating layer to provide an article comprising an electroless metal coating which is substantially free of pinhole imperfections allowing fluid communication between the substrate and the environment.

### BACKGROUND

The subject matter disclosed herein relates generally to articles comprising electroless metal coatings and methods for curing imperfections in such electroless metal coatings.

Electroless metal coatings are used in a wide variety of applications in which a protective coating is needed to improve the performance characteristics of the substrate underlying the electroless metal coating. The utility of such coatings lies chiefly in the enhanced physical properties (for example hardness) of the electroless metal coating relative to the substrate on which it is disposed. In addition, electroless metal coatings may be used to protect an article which is otherwise susceptible to corrosion from chemicals present in environments in which the article is employed. In addition, because electroless metal coatings are applied to the substrate from solution, the substrate may have a variety of shapes, sizes and perforations and still achieve a coating of uniform composition and thickness. A substantial body of information regarding the preparation and properties of electroless metal coatings is currently available, particularly in the area of coatings comprising nickel-phosphorous or nickel-boron alloys.

Notwithstanding the technical achievements made to date in the area of electroless metal coatings, further improvements are needed in order to maximize the utility of these coatings. In certain instances, for example where the surface of the substrate to be coated is soiled or is characterized by a high level of surface roughness, imperfections such as pinholes and pits may develop as the electroless metal coating is deposited on the surface of the substrate. Imperfections in the electroless metal coating can lead to a shortened useful lifespan of the article comprising the electroless metal coating. Hence, in instances in which the electroless metal coating is created with structural imperfections such as pinholes or pits, and in instances in which such imperfections requiring repair develop as a result of use and wear, there exists a need to correct such imperfections by means other than resubjecting the substrate to electroless metal coating conditions.

Therefore, it would be advantageous to provide articles comprising electroless metal coatings in which imperfections such as pinholes, which would otherwise be present, have been eliminated, and to provide methods for the preparation of such articles.

### BRIEF DESCRIPTION

In one embodiment, the present invention provides a method for sealing pinholes in an electroless metal coating, said method comprising: (a) coating a substrate with an electroless metal coating layer to provide a coated article comprising an electroless metal coating in contact with the surface of the substrate, said electroless metal coating being characterized by the presence of pinhole imperfections which allow fluid communication between the substrate and the environment; (b) applying a layer of a curable epoxy sealant over the electroless metal coating layer and filling the pinhole imperfections; (c) curing the curable epoxy sealant to provide a cured epoxy overcoating layer; and (d) removing a substantial portion of the cured epoxy overcoating layer to provide an article comprising an electroless metal coating which is substantially free of pinhole imperfections allowing fluid communication between the substrate and the environment.

In an alternate embodiment, the present invention provides a method for sealing pinholes in an electroless metal coating, said method comprising: (a) providing an article comprising a substrate and an electroless metal coating layer in contact with the surface of the substrate, said electroless metal coating being characterized by the presence of pinhole imperfections which allow fluid communication between the substrate and the environment; (b) applying a layer of a curable epoxy sealant over the electroless metal coating layer and filling the pinhole imperfections; (c) curing the curable epoxy sealant to provide a cured epoxy overcoating layer; and (d) removing a substantial portion of the cured epoxy overcoating layer to provide an article comprising an electroless metal coating which is substantially free of pinhole imperfections allowing fluid communication between the substrate and the environment.

In yet another embodiment, the present invention provides article comprising: (a) a substrate; and (b) an electroless metal coating in contact with the substrate and forming an outer surface of the article, said electroless metal coating being characterized by the presence of pinhole imperfections, said pinhole imperfections being substantially filled by a cured epoxy sealant.

### BRIEF DESCRIPTION OF THE DRAWING FIGURES

These and other features, aspects, and advantages of the present invention will become better understood when the following detailed description is read with reference to the accompanying drawings in which like characters represent like parts throughout the drawings, wherein:

FIG. 1 illustrates an embodiment of the invention which is a method;

FIG. 2 illustrates a coated article comprising a substrate and an electroless metal coating in contact with the surface of the substrate, the electroless metal coating being characterized by the presence of pinhole and pit imperfections;

FIG. 3 illustrates the article of FIG. 2 to which has been applied a curable epoxy sealant;

FIG. 4 illustrates the article of FIG. 3 after curing the epoxy sealant and removing a substantial portion of that portion of the cured epoxy sealant forming a cured epoxy overcoating layer; and

FIG. 5 illustrates one or more embodiments of the present invention.

### DETAILED DESCRIPTION

As noted, in one embodiment, the present invention provides a method for sealing pinholes in an electroless metal coating, said method comprising: (a) coating a substrate with an electroless metal coating layer to provide a coated article comprising an electroless metal coating in contact with the surface of the substrate, said electroless metal coating being characterized by the presence of pinhole imperfections which allow fluid communication between the substrate and the environment; (b) applying a layer of a curable epoxy sealant over the electroless metal coating layer and filling the pinhole imperfections; (c) curing the curable epoxy sealant to provide a cured epoxy overcoating layer; and (d) removing a substantial portion of the cured epoxy overcoating layer to provide an article comprising an electroless metal coating which is substantially free of pinhole imperfections allowing fluid communication between the substrate and the environment.

As used herein, the term electroless metal coating refers to a metal coating on a substrate formed by chemical reduction of metal ions in solution in the presence of the substrate. A variety of such electroless metal coatings is known and includes electroless copper coatings, electroless gold coatings, electroless silver coatings, and electroless nickel coatings. In one embodiment, the electroless metal coating provided by the present invention is a nickel-phosphorous alloy coating. In an alternate embodiment, the electroless metal coating provided by the present invention is a nickel-boron alloy coating. In yet another embodiment, the electroless metal coating provided by the present invention is an electroless nickel coating comprising poly(tetrafluoroethylene).

The substrate can be any substrate capable of supporting the electroless metal coating but is typically a material to which the electroless metal coating binds strongly. Substrates may be inorganic materials such as metals, or organic materials such as plastics, or composite materials, for example an organic polymer comprising an inorganic filler. As noted, in one embodiment, the substrate is a metallic substrate. For example, the substrate can be a metallic substrate comprising at least one of the following elements iron, chromium, nickel, cobalt, copper, aluminum, or titanium. In one embodiment, the substrate comprises steel. In one embodiment, the substrate comprises a low alloy carbon steel.

As noted, electroless metal coatings may at times be characterized by the presence of pinhole imperfections which allow fluid communication between the substrate and the environment. Such imperfections may result in damage to the substrate when the article is employed in an environment corrosive to the substrate. In a variety of applications, the primary purpose of the electroless metal coating is to serve as a protective barrier which isolates a sensitive substrate material from such a corrosive environment. Pinhole imperfections are believed to arise when a bubble forms at the surface of the substrate being coated during the electroless metal coating process. The electroless metal coating process is described in detail in the Experimental Section of this disclosure. Other imperfections include pits which represent localized domains in the coating where the electroless metal coating is thinner than the adjacent coating. For many applications, pits are considered undesirable surface features in an electroless metal coating.

It has been found that if a curable epoxy sealant having a sufficiently low viscosity is applied to the surface (or surfaces) of the substrate, the sealant will penetrate pinholes and pits present in the electroless metal coating. Typically, a suitable curable epoxy sealant will have a viscosity at ambient temperature in a range from about 20 to about 1200 cps. In certain embodiments the viscosity of the curable epoxy sealant may be lowered by the addition of a diluent, such as an organic solvent. A very wide variety of epoxy sealants are known to those of ordinary skill in the art and many of such epoxy sealants are available commercially. Suitable curable epoxy sealants include two part epoxy resins such as bisphenol A diglycidyl ether (the epoxy resin component) and triethylenetetramine (the hardener component), bisepoxides such as butadiene dimer bisepoxide, and the like. In one embodiment, the epoxy sealant comprises an acid sensitive epoxide and a photo acid generator (PAG) such as an organic iodonium salt, for example diphenyl iodonium tetrafluoroborate.

In one embodiment, the curable epoxy sealant comprises a filler, for example fumed silica. In another embodiment, the curable epoxy sealant comprises a nanoparticulate filler, for example a nanoparticulate clay. In one embodiment, the curable epoxy sealant comprises a nanoparticulate filler selected from the group consisting of silicon carbide, boron nitride, and diamond. In one embodiment, the curable epoxy sealant comprises a silicon carbide nanoparticulate filler. In another embodiment, the curable epoxy sealant comprises a boron nitride nanoparticulate filler.

Curable epoxy sealants are especially useful in the practice of the present invention because they are available in formulations having a variety of viscosity ranges, penetrate pinhole imperfections, and may be cured efficiently under a variety of conditions, for thermally or with electromagnetic radiation, to form a cured epoxy sealant disposed within the pinholes and on the surface of the substrate as a cured epoxy overcoating layer. Moreover, the cured epoxy overcoating layer is readily abraded from the surface of the substrate by techniques such as sanding and abrasive air blasting. Abrasive air blasting is a technique in which solid particulates are propelled by compressed air against a work surface. The cured epoxy sealant disposed within a pinhole in an electroless metal coating or disposed within a suitably sized pit on the surface of an electroless metal coating is less susceptible to abrasive separation from the substrate than is the cured epoxy overcoating layer. Thus, it is possible to remove the cured epoxy overcoating layer without removing the cured epoxy resin disposed within a pinhole, for example. In various embodiments, it is possible to select an abrasive agent characterized by an abrasive particle size larger than the outer surface diameter of the pinholes or pits in the electroless metal coating thereby assuring minimal interaction between the abrasive medium and the cured epoxy sealant disposed within the pinholes or pits. Suitable abrasive particulate materials include sand, glass particles, pumice, and sodium bicarbonate.

As used herein, the phrase “removing a substantial portion of the cured epoxy overcoating layer” means removing in one embodiment at least 10 percent, in another embodiment least 40 percent, in another embodiment at least 70 percent, and in yet another embodiment at least 95 percent of the total amount of a cured epoxy overcoating layer disposed on a surface of a substrate.

An article comprising an electroless metal coating which is “substantially free” of pinhole imperfections allowing fluid communication between the substrate and the environment is defined herein as an article in which at least 95 percent of all pinhole imperfections present in the electroless metal coating comprise sufficient cured epoxy sealant to inhibit fluid communication between the substrate and the environment.

In one embodiment, the electroless metal coating used in the practice of the present invention comprises pinholes characterized by an average pinhole diameter of less than about 200 microns, in another embodiment less than about 100 microns, and in yet another embodiment less than about 50 microns. Similarly, with respect to pits present on the surface of the electroless metal coating used in the practice of the present invention, the electroless metal coating may comprise pits characterized by an average pit diameter of less than about 200 microns, in another embodiment less than about 100 microns, and in yet another embodiment less than about 50 microns.

As noted, the electroless metal coating is typically of relatively uniform thickness. In one embodiment, the electroless metal coating has an average thickness in a range from about 1 micron to about 500 microns. In another embodiment, the electroless metal coating has an average thickness in a range from about 1 micron to about 100 microns. In yet another embodiment, the electroless metal coating has an average thickness in a range from about 1 micron to about 50 microns.

In one embodiment, the electroless metal coating is an electroless nickel coating comprising phosphorous. Such coatings may at times herein be referred to as electroless nickel phosphorous coatings. In one embodiment, the electroless nickel phosphorous coating comprises sufficient phosphorous to be recognized as a “high phosphorous” electroless nickel coating. Those of ordinary skill in the art will understand that such high phosphorous coatings offer outstanding resistance to corrosive environments. In another embodiment, the electroless metal coating is an electroless nickel coating characterized as “low phosphorous” or “hard”. Again, those of ordinary skill in the art will appreciate the advantages of such low phosphorous electroless metal coatings. In yet another embodiment, the electroless metal coating is an electroless nickel coating comprising poly(tetrafluoroethylene) particles. Such electroless nickel composite coatings are prized for reduced surface friction at contact points with other surfaces, for example where the electroless nickel composite coating is in contact with another moving part in a device or machine.

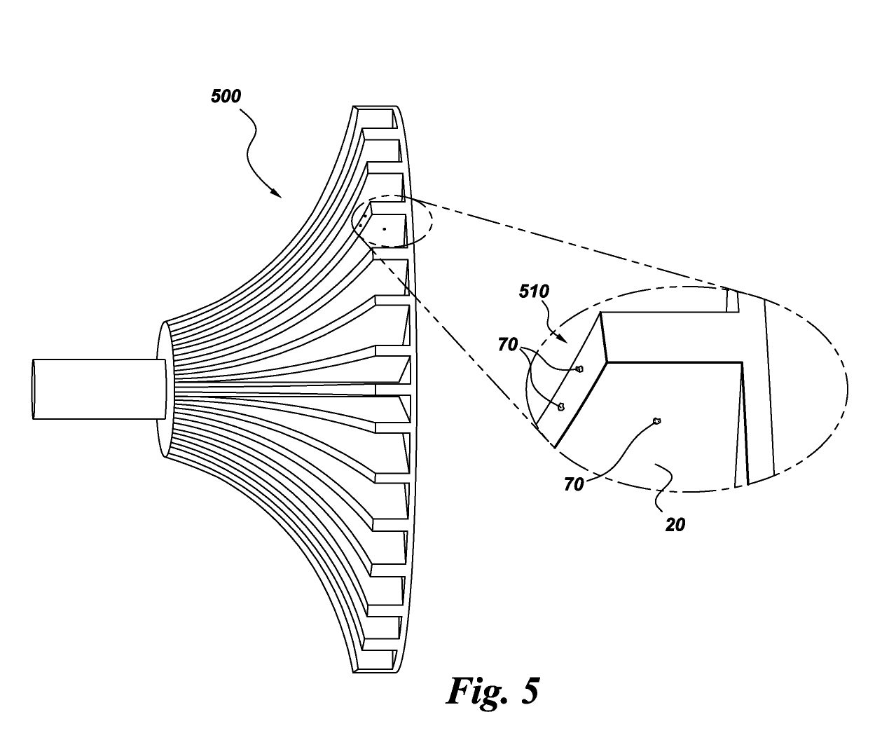

As noted, the article provided by the present invention comprises an electroless metal coating which is substantially free of pinhole imperfections allowing fluid communication between the substrate and the environment. In one embodiment, the article is a component of a turbomachine. In one embodiment, the article is a turbine blade. In another embodiment, the article is a compressor blade. In another embodiment, the article is a gas impeller component of a gas compressor (See for example FIG. 5). In yet another embodiment, the article is a component of a fluid pump.

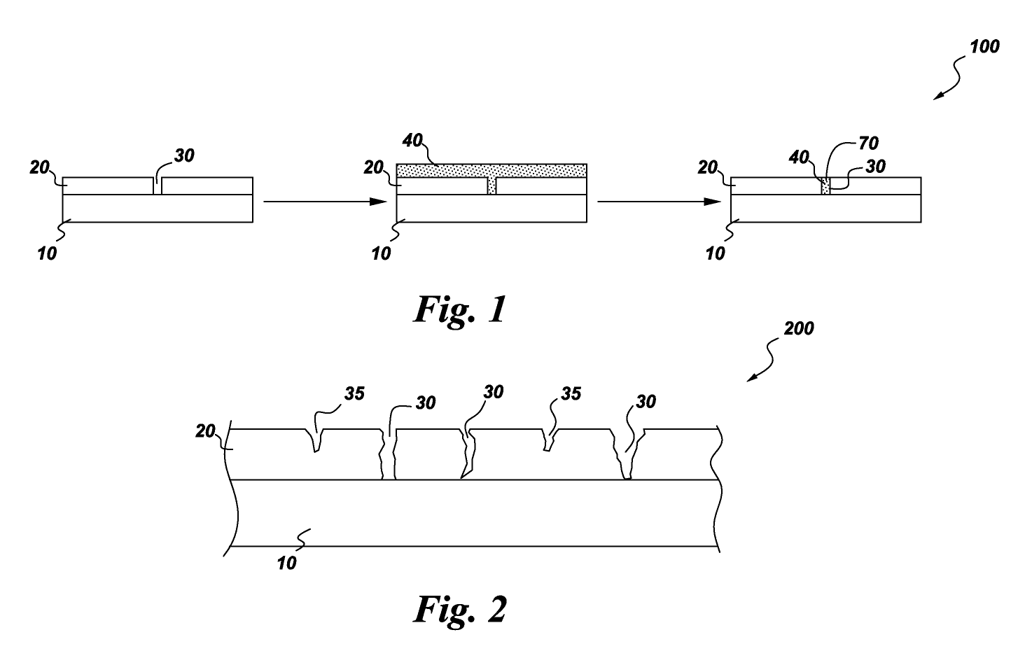

Referring to FIG. 1, the figure illustrates an embodiment of the present invention which is a method 100 for sealing pinholes in an electroless metal coating. A substrate 10 coated with an electroless metal coating 20 is provided, the electroless metal coating being characterized by the presence of a pinhole 30. The electroless metal coating 20 is shown as being in contact with the surface of the substrate 10. Pinhole 30 is shown as allowing fluid communication between the surface of substrate 10 and the environment.

Still referring to FIG. 1, in a first method step (indicated by a horizontal arrow) a curable epoxy sealant (not shown) is applied over the electroless metal coating layer and is cured to afford a cured epoxy sealant 40. The curable epoxy sealant is selected from epoxy sealants having sufficiently low viscosities such that the epoxy sealant flows into and substantially fills pinhole 30. Upon curing of the curable epoxy sealant, a cured epoxy overcoating layer is formed which is in contact with the surface of the electroless metal coating 20. The cured epoxy overcoating layer is distinguished from the cured epoxy sealant present within pinhole 30.

Still referring to FIG. 1, in a second method step, the cured epoxy overcoating layer is removed from the surface of the electroless metal coating to provide an article comprising a substrate 10, and an electroless metal coating 20 which is substantially free of pinhole imperfections. The pinhole 30 filled with cured epoxy sealant 40 is numbered 70 in FIG. 1 and is referred to as a “filled pinhole”. The cured epoxy sealant 40 present in filled pinhole 70 prevents fluid communication between the substrate 10 and the environment. As noted, the cured epoxy overcoating layer may be removed by any convenient abrasive technique such as grit blasting, sanding, grinding, and air abrasion.

Referring to FIGS. 2-4, the figures illustrate an embodiment of the present invention in which imperfections are eliminated in an electroless nickel plated article 200 comprising a substrate 10 and an electroless nickel coating 20 comprising pinholes 30 and pits 35, the coating 20 being in contact with the surface of substrate 10.

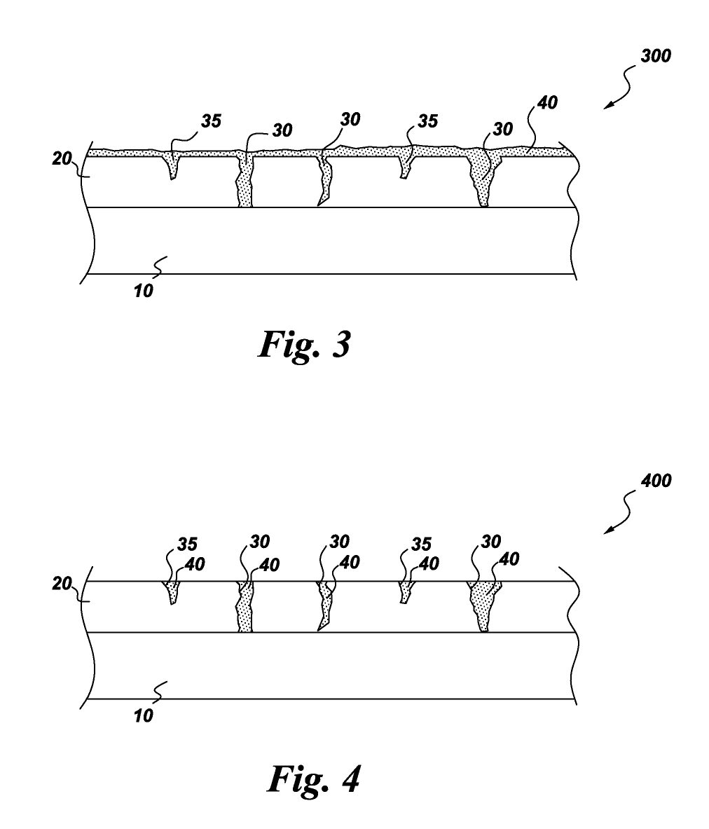

Referring to FIG. 3, the figure illustrates the article of FIG. 2 to which has been applied a curable epoxy sealant and the sealant cured to give article 300. The figure shows pinholes 30 and pits 35 which are filled with the cured epoxy sealant 40, the remainder of the cured epoxy sealant 40 being disposed on the surface of the electroless nickel coating as a cured epoxy overcoating layer.

Referring to FIG. 4, the figure illustrates an article 400 which is derived from the article of FIG. 3 following removal of a substantial portion of that portion of the cured epoxy sealant forming a cured epoxy overcoating layer but leaving the curable epoxy sealant 40 disposed within pinholes 30 and pits 35 intact.

Referring to FIG. 5, the figure illustrates an embodiment of the invention in which a gas impeller 500 component of a gas compressor is shown following repair of pinhole imperfections in an electroless metal coating 20 disposed on a substrate (not shown in this view). Enlarged view 510 shows a blade of the gas impeller in which the outer electroless metal coating 20 comprises filled pinholes 70 which prevent fluid communication of gases being operated upon by the impeller from contacting the substrate (not shown) underlying the electroless metal coating. In an embodiment illustrated in part by FIG. 5, a gas impeller 500 having its exposed surfaces coated with an electroless metal coating 20 comprising pinhole imperfections is provided. Using a suitable analytical test indicative of fluid communication between the environment and the substrate underlying the electroless metal coating, such as the ferroxyl test (ASTM B733), a technician may identify the blades comprising pinhole imperfections in the electroless metal coating, apply a suitable curable epoxy sealant to those blades requiring repair, cure the epoxy sealant and abrade the cured epoxy overcoating layer from the surface of the electroless metal coating to provide a gas impeller substantially free of pinhole imperfections allowing fluid communication between the substrate and the environment.

Finally, those of ordinary skill in the art will appreciate that one of the advantages provided by the present invention is that imperfections such as pinholes and pits created during the deposition of an electroless metal coating on a substrate, or which develop as a result of use and wear of an article comprising an electroless metal coating, may be eliminated without having to resubject the article to electroless metal coating conditions.

### Experimental Section

Pinhole Detection: Pinholes in electroless metal coatings were detected using the ferroxyl test, ASTM B733.

Test Coupon Preparation: Test coupons made of A182 F22 steel were treated with ferric chloride solution at 50° C. for 10 minutes to provide test coupons having a surface roughness of about 50 Ra and a significant number of deep narrow pits which are susceptible to pinhole generation during.

Electroless Nickel Plating General: Test coupons were subjected to electroless nickel plating (EPN) to provide a test coupon comprising a steel (182 F22) substrate and an electroless nickel metal coating in contact with the surface of the substrate. When the coated test coupons were subjected to the ferroxyl test and afforded a deep blue color during the test indicating the presence of pinhole imperfections in the EPN coating allowing fluid communication between the steel substrate and the ferric chloride test solution.

Electroless Nickel Plating Detailed Description: Glassware used in electroless plating procedures was either newly purchased or first treated with 10% nitric acid for 2 hours at 60° C. The glassware is then thoroughly rinsed with filtered high purity water and sealed with PARAFILM.

Electroless Plating Solution: (Use no magnetic stir bars!) A clean Erlenmeyer flask was charged in order with the following: filtered high purity water (1000 mL), sodium hypophosphite (27 grams), nickel sulfate (20 grams) and sodium succinate (16 grams). The resultant solution was vacuum filtered through a 0.6 micron or finer Millipore filter (45 mm diameter filter) into a clean vacuum flask and the filtered solution was transferred to a clean Erlenmeyer flask and sealed with PARAFILM.

Test Coupon Plating: The electroless plating solution was added to a clean, scratch-free 500 mL beaker equipped with a clean thermometer. A test coupon was suspended in the solution on a TC wire. The pH of the electroless plating solution was monitored using a pH strip and sensitive in the range pH 5 to pH 8 and was maintained at about pH 7 through the dropwise addition of lactic acid solution. The electroless plating of the test coupon was continued until the plating solution turned light green. Plated test coupons were removed from the plating bath, rinsed with water, dried and stored until used. Test coupons plated in this manner tested positive for pinholes in the ferroxyl test.

Pinhole Sealing with Colloidal Silica: Electroless nickel plated test coupons were treated with LP30 colloidal silica solution using an artist's air brush (Aztek A270), dried over night in air and then cured at 180° C. for 1 hour.

Pinhole Sealing with Epoxy Primer: Electroless nickel plated test coupons were coated with the manufacturer's suggested mixture (Akzo Nobel U-Tech E350) of hardener and epoxy resin using an artist's air brush (Aztek A270) to apply the resin hardener combination in the same manner used to apply the colloidal silica. The resultant epoxy overcoating layer was allowed to harden for 1 hour at room temperature and then cured at 180° C. for 1 hour.

Corrosion Testing of Test Coupons: Coupons were immersed in a corrosion test method NACE TM0177 solution, which consisted of 0.5 wt % glacial acetic acid, and 5% NaCl under 1 atmosphere of hydrogen sulfide H₂S for 720 h, with a 100% H₂S gas purge throughout the duration of the test.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for sealing pinholes in an electroless metal coating, said method comprising:
(a) coating a substrate with an electroless metal coating layer to provide a coated article comprising an electroless metal coating in contact with the surface of the substrate, said electroless metal coating being characterized by the presence of pinhole imperfections which allow fluid communication between the substrate and the environment;
(b) applying a layer of a curable epoxy sealant over the electroless metal coating layer and filling the pinhole imperfections;
(c) curing the curable epoxy sealant to provide a cured epoxy overcoating layer; and
(d) removing a substantial portion of the cured epoxy overcoating layer to provide an article comprising an electroless metal coating which is substantially free of pinhole imperfections allowing fluid communication between the substrate and the environment.

2. The method according to claim 1, wherein the substrate is a metallic substrate.

3. The method according to claim 1, wherein the substrate has a surface roughness in a range from about 25 to about 1000 Ra.

4. The method according to claim 1, wherein the electroless metal coating layer is an electroless nickel phosphorous coating.

5. The method according to claim 4, wherein the nickel phosphorous coating is a high phosphorous coating.

6. The method according to claim 1, wherein the curable epoxy sealant has a viscosity in a range from about 20 about 1200 cps at ambient temperature.

7. The method according to claim 1, wherein the cured epoxy overcoating layer is removed by abrasion.

8. The method according to claim 1, wherein the article provided in step (d) is a compressor blade.

9. The method according to claim 1, wherein the electroless metal coating comprises poly(tetrafluoroethylene) particles.

10. A method for sealing pinholes in an electroless metal coating, said method comprising:
(a) providing an article comprising a substrate and an electroless metal coating layer in contact with the surface of the substrate, said electroless metal coating being characterized by the presence of pinhole imperfections which allow fluid communication between the substrate and the environment;
(b) applying a layer of a curable epoxy sealant over the electroless metal coating layer and filling the pinhole imperfections;
(c) curing the curable epoxy sealant to provide a cured epoxy overcoating layer; and
(d) removing a substantial portion of the cured epoxy overcoating layer to provide an article comprising an electroless metal coating which is substantially free of pinhole imperfections allowing fluid communication between the substrate and the environment.

11. The method according to claim 10, wherein the substrate is a metallic substrate.

12. The method according to claim 11, wherein the metallic substrate comprises low alloy carbon steel.

13. The method according to claim 1, wherein the electroless metal coating is an electroless nickel phosphorous coating.

14. The method according to claim 13, wherein the nickel phosphorous coating is a high phosphorous coating.

15. The method according to claim 1, wherein the curable epoxy sealant has a viscosity in a range from about 20 about 1200 cps at ambient temperature.

16. An article comprising:
(a) a substrate; and
(b) an electroless metal coating in contact with the substrate and forming an outer surface of the article, said electroless metal coating being characterized by the presence of pinhole imperfections, said pinhole imperfections being substantially filled by a cured epoxy sealant.

17. The article according to claim 16, wherein said pinhole imperfections are characterized by a pinhole diameter at the surface of the electroless metal coating in a range from about 1 micron to about 200 microns.

18. The article according to claim 16, wherein said cured epoxy sealant comprises a filler.

19. The article according to claim 18, wherein said filler is nanoparticulate.

20. The article according to claim 19, wherein said filler is selected from the group consisting of silicon carbide, boron nitride, and diamond.

21. The article according to claim 16, which is a gas impeller component of a gas compressor.

22. The article according to claim 16, which is a component of a fluid pump.
